(19) United States
(12) Patent Application Publication
(10) Pub. No.: US 2025/0085591 A1
(43) Pub. Date: Mar. 13, 2025

(54) LIQUID CRYSTAL DISPLAY DEVICE

(71) Applicant: TCL CHINA STAR OPTOELECTRONICS TECHNOLOGY CO., LTD., Shenzhen, Guangdong (CN)

(72) Inventors: Yutong Han, Shenzhen, Guangdong (CN); Juncheng Xiao, Shenzhen, Guangdong (CN); Ji Li, Shenzhen, Guangdong (CN); Xiaojin He, Shenzhen, Guangdong (CN)

(73) Assignee: TCL CHINA STAR OPTOELECTRONICS TECHNOLOGY CO., LTD., Shenzhen, Guangdong (CN)

(21) Appl. No.: 17/597,935

(22) PCT Filed: Jan. 14, 2022
(86) PCT No.: PCT/CN2022/072107

§ 371 Date: Nov. 20, 2024

(30) Foreign Application Priority Data
Dec. 30, 2021 (CN) 202111638128.7

(51) Int. Cl. G02F 1/1335

(52) U.S. Cl. CPC G02F 1/133614; G02F 1/133512; G02F 1/133514; G02F 1/133528

(57) ABSTRACT

The present application provides a liquid crystal display (LCD) device. The liquid crystal display device includes a first substrate, a second substrate, a liquid crystal layer, and an upper polarizer; the second substrate is disposed opposite to the first substrate; the liquid crystal layer is disposed between the first substrate and the second substrate; the upper polarizer is disposed on a side of the second substrate away from the liquid crystal layer, the upper polarizer includes a polarization layer and a color conversion layer, and the color conversion layer is located on a side of the polarization layer away from the liquid crystal layer.

### FIELD OF INVENTION

The present disclosure relates to the field of display technologies, and in particular, to a liquid crystal display (LCD) device.

### BACKGROUND OF INVENTION

When a color conversion layer including a color conversion material, such as a down-conversion fluorescent material, is disposed in a color filter (CF) substrate of a liquid crystal display (LCD), the polarized light excites the down-conversion fluorescent material. Due to the fluorescence polarization characteristic, a polarization state of emitted light generated by the excited down-conversion fluorescent material changes.

### SUMMARY

### Technical Problem

The polarization state of emitted light generated by the excited down-conversion fluorescent material changes, resulting in light leakage of the LCD in a dark state. As a result, the contrast of the LCD is greatly reduced.

### Solution to the Problem

### Technical Solution

Embodiments of the present disclosure provide a liquid crystal display (LCD) device, to resolve the technical problem that the contrast of an LCD is reduced in the prior art.

An embodiment of the present disclosure provides a liquid crystal display device, including:
a first substrate;
a second substrate disposed opposite to the first substrate;
a liquid crystal layer disposed between the first substrate and the second substrate; and
an upper polarizer disposed on a side of the second substrate away from the liquid crystal layer, where the upper polarizer includes a polarization layer and a color conversion layer, and the color conversion layer is located on a side of the polarization layer away from the liquid crystal layer.

Optionally, in some embodiments of the present disclosure, the upper polarizer further includes a first protective layer. The first protective layer is located between the polarization layer and the color conversion layer.

Optionally, in some embodiments of the present disclosure, the upper polarizer further includes a protective film and a first bonding layer. The protective film is located on a side of the color conversion layer away from the polarization layer. The first bonding layer is located between the protective film and the color conversion layer.

Optionally, in some embodiments of the present disclosure, the upper polarizer further includes a second protective layer. The second protective layer is located between the color conversion layer and the first bonding layer.

Optionally, in some embodiments of the present disclosure, a third protective layer and a second bonding layer are successively disposed on a side of the polarization layer away from the color conversion layer. The third protective layer is disposed between the polarization layer and the second bonding layer.

Optionally, in some embodiments of the present disclosure, the liquid crystal display device includes a plurality of pixel regions, each of the pixel regions includes a first sub-pixel region, a second sub-pixel region, and a third sub-pixel region, the color conversion layer includes a first color conversion portion, a second color conversion portion, and a light transmissive portion that are spaced apart from each other. The first color conversion portion and the second color conversion portion are configured to convert light of different colors. The first color conversion portion is located in the first sub-pixel region, the second color conversion portion is located in the second sub-pixel region, and the light transmissive portion is located in the third sub-pixel region.

Optionally, in some embodiments of the present disclosure, the first sub-pixel region is a red sub-pixel region, the second sub-pixel region is a green sub-pixel region, and the third sub-pixel region is a blue sub-pixel region, light emitted by a backlight module of the liquid crystal display device is blue light, a material of the first color conversion portion includes a red fluorescent material and a red filter material. A material of the second color conversion portion includes a green fluorescent material and a green filter material, and the light transmissive portion includes a blue filter material.

Optionally, in some embodiments of the present disclosure, the red fluorescent material includes red fluorescent powder or a red quantum dot. The green fluorescent material includes green fluorescent powder or a green quantum dot.

Optionally, in some embodiments of the present disclosure, the first sub-pixel region is a red sub-pixel region, the second sub-pixel region is a green sub-pixel region, and the third sub-pixel region is a blue sub-pixel region, light emitted by a backlight module of the liquid crystal display device is blue light, a material of the first color conversion portion includes a red fluorescent material. A material of the second color conversion portion includes a green fluorescent material. The polarizer further includes a blue light absorption layer. The blue light absorption layer is located on sides of the first color conversion portion and the second color conversion portion away from the polarization layer.

Optionally, in some embodiments of the present disclosure, the blue light absorption layer includes a red filter portion and a green filter portion. The red filter portion is located on a side of the first color conversion portion away from the polarization layer. The green filter portion is located on a side of the second color conversion portion away from the polarization layer.

Optionally, in some embodiments of the present disclosure, a material of the light transmissive portion includes a blue filter material. The upper polarizer further includes a blue filter portion. The blue filter portion is disposed on a same layer as the blue light absorption layer and located on a side of the light transmissive portion away from the polarization layer.

Optionally, in some embodiments of the present disclosure, the light transmissive portion and the blue filter portion are integrally formed.

Optionally, in some embodiments of the present disclosure, the upper polarizer further includes light-shielding portions. The light-shielding portions are respectively located between the first color conversion portion and the second color conversion portion, between the first color conversion portion and the light transmissive portion, and between the second color conversion portion and the light transmissive portion.

An embodiment of the present disclosure further provides an LCD device, including: a first substrate;
a second substrate disposed opposite to the first substrate;
a liquid crystal layer disposed between the first substrate and the second substrate; and
an upper polarizer disposed on a side of the second substrate away from the liquid crystal layer; where the upper polarizer includes a polarization layer, a color conversion layer, a first protective layer, a protective film, and a first bonding layer, the color conversion layer is located on a side of the polarization layer away from the liquid crystal layer, the first protective layer is located between the polarization layer and the color conversion layer, the protective film is located on a side of the color conversion layer away from the polarization layer, and the first bonding layer is located between the protective film and the color conversion layer.

Optionally, in some embodiments of the present disclosure, the liquid crystal display device includes a plurality of pixel regions, each of the pixel regions includes a first sub-pixel region, a second sub-pixel region, and a third sub-pixel region, the color conversion layer includes a first color conversion portion, a second color conversion portion, and a light transmissive portion that are spaced apart from each other, the first color conversion portion and the second color conversion portion are configured to convert light of different colors, the first color conversion portion is located in the first sub-pixel region, the second color conversion portion is located in the second sub-pixel region, and the light transmissive portion is located in the third sub-pixel region.

Optionally, in some embodiments of the present disclosure, the first sub-pixel region is a red sub-pixel region, the second sub-pixel region is a green sub-pixel region, and the third sub-pixel region is a blue sub-pixel region, light emitted by a backlight module of the liquid crystal display device is blue light, a material of the first color conversion portion includes a red fluorescent material and a red filter material, a material of the second color conversion portion includes a green fluorescent material and a green filter material, and the light transmissive portion includes a blue filter material.

Optionally, in some embodiments of the present disclosure, the red fluorescent material includes red fluorescent powder or a red quantum dot, and the green fluorescent material includes green fluorescent powder or a green quantum dot.

Optionally, in some embodiments of the present disclosure, the first sub-pixel region is a red sub-pixel region, the second sub-pixel region is a green sub-pixel region, and the third sub-pixel region is a blue sub-pixel region, light emitted by a backlight module of the liquid crystal display device is blue light, a material of the first color conversion portion includes a red fluorescent material, a material of the second color conversion portion includes a green fluorescent material, and the polarizer further includes a blue light absorption layer, where the blue light absorption layer is located on sides of the first color conversion portion and the second color conversion portion away from the polarization layer.

Optionally, in some embodiments of the present disclosure, the blue light absorption layer includes a red filter portion and a green filter portion, where the red filter portion is located on a side of the first color conversion portion away from the polarization layer, and the green filter portion is located on a side of the second color conversion portion away from the polarization layer.

Optionally, in some embodiments of the present disclosure, a material of the light transmissive portion includes a blue filter material, and the upper polarizer further includes a blue filter portion, where the blue filter portion is disposed on a same layer as the blue light absorption layer and located on a side of the light transmissive portion away from the polarization layer.

### Beneficial Effects of the Invention

### Beneficial Effects

Compared with an LCD device in the prior art, the LCD device provided in the present disclosure integrates the color conversion layer in the upper polarizer, and the color conversion layer is disposed on the side of the polarization layer away from the liquid crystal layer. When the LCD device is in a dark state, backlight first passes through a lower polarizer and forms polarized light, and next, the polarized light passes through the liquid crystal layer. Then, the polarized light passing through the liquid crystal layer enters the color conversion layer after undergoing polarization analysis by the polarization layer of the upper polarizer. Since the polarized light is not affected by the color conversion layer before entering the polarization layer, a polarization state of the polarized light is not changed. By means of the polarization analysis by the polarization layer, the LCD device is prevented from light leakage in the dark state. Therefore, the contrast of the LCD device can be greatly improved.

### BRIEF DESCRIPTION OF DRAWINGS

### Description of the Drawings

To describe technical solutions in embodiments of the present disclosure more clearly, the following briefly introduces the accompanying drawings required for describing the embodiments. Apparently, the accompanying drawings in the following description show only some embodiments of the present disclosure, and a person skilled in the art may still derive other accompanying drawings from these accompanying drawings without creative efforts.

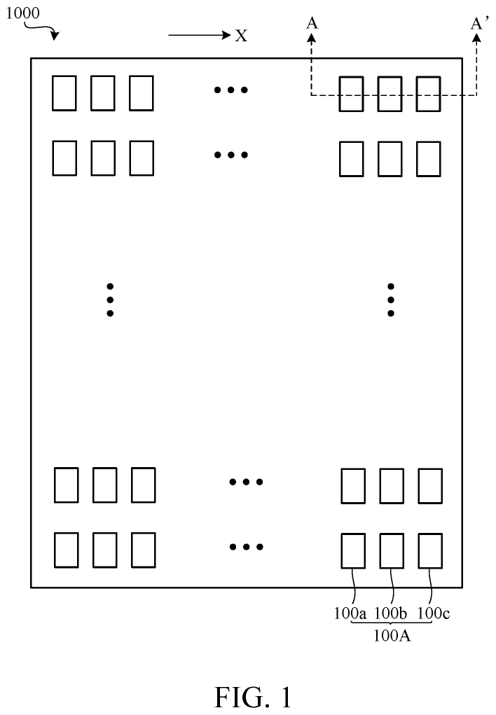

FIG. 1 is a schematic diagram of a plane structure of a liquid crystal display device according to the present disclosure.

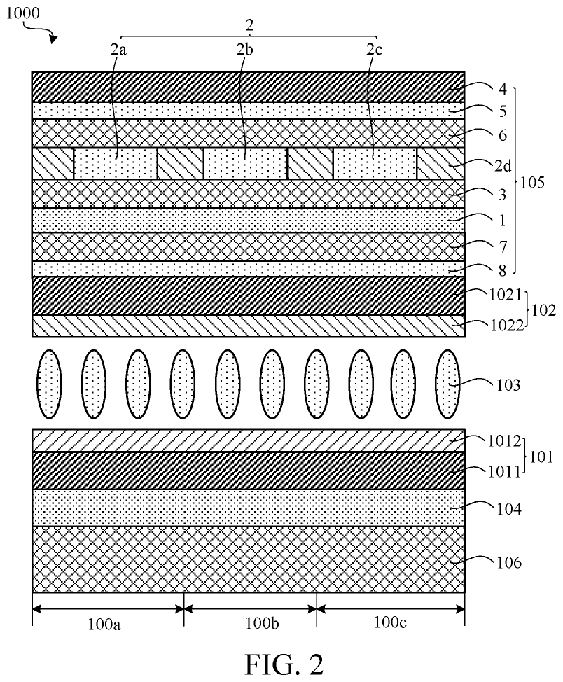

FIG. 2 is a schematic sectional view of a first embodiment of the liquid crystal display device in FIG. 1 taken along a line A-A′.

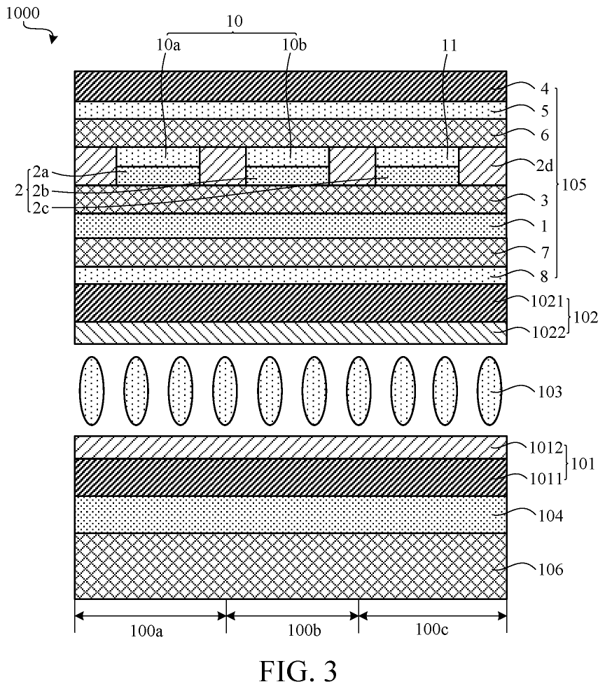

FIG. 3 is a schematic sectional view of a second embodiment of the liquid crystal display device in FIG. 1 taken along a line A-A′.

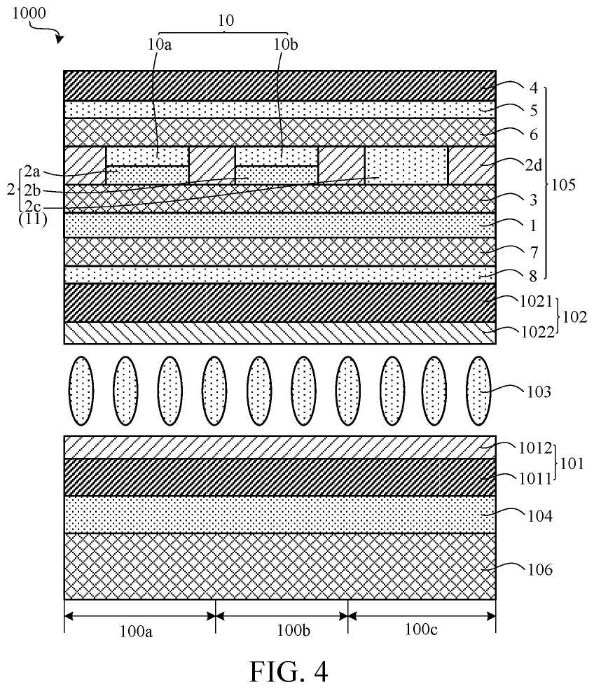

FIG. 4 is a schematic sectional view of a third embodiment of the liquid crystal display device in FIG. 1 taken along a line A-A′.

### DETAILED DESCRIPTION OF EMBODIMENTS

### Embodiments of the Present Invention

The technical solutions of this application are clearly and completely described below with reference to the accompanying drawings of the present disclosure. Apparently, the described embodiments are merely some rather than all of the embodiments of the present disclosure. All other embodiments obtained by a person skilled in the art based on the embodiments of the present disclosure without creative efforts shall fall within the protection scope of the present disclosure. In addition, it should be understood that the specific implementations described herein are merely used to describe and explain the present disclosure, but are not intended to limit the present disclosure. In the present disclosure, without the contrary explanation, the nouns of locality such as “upper” and “lower” usually refer to upper and lower of an apparatus in actual use or an operating state, and specifically, to a drawing direction of the accompanying drawings; and “inside” and “outside” are for an outline of the apparatus.

The embodiments of the present disclosure provide a polarizer and a liquid crystal display (LCD) device. Respective detailed descriptions are provided below. It should be noted that the description sequence of the following embodiments is not a limitation to the exemplary sequence of the embodiments.

The present disclosure provides a liquid crystal display device. The liquid crystal display device includes a first substrate, a second substrate, a liquid crystal layer, and an upper polarizer; the second substrate is disposed opposite to the first substrate; the liquid crystal layer is disposed between the first substrate and the second substrate; the upper polarizer is disposed on a side of the second substrate away from the liquid crystal layer, the upper polarizer includes a polarization layer and a color conversion layer, and the color conversion layer is located on a side of the polarization layer away from the liquid crystal layer.

The liquid crystal display device provided in the present disclosure integrates the color conversion layer in the upper polarizer, and the color conversion layer is disposed on the side of the polarization layer away from the liquid crystal layer. When the LCD device in a dark state, backlight first passes through a lower polarizer and forms polarized light, and next, the polarized light passes through the liquid crystal layer. Then, the polarized light passing through the liquid crystal layer enters the color conversion layer after undergoing polarization analysis by the polarization layer of the upper polarizer. Since the polarized light is not affected by the color conversion layer before entering the polarization layer, a polarization state of the polarized light is not changed. By means of the polarization analysis by the polarization layer, the LCD device is prevented from light leakage in the dark state. Therefore, the contrast of the LCD device can be greatly improved.

The liquid crystal display device provided in the present disclosure is described in detail below with reference to detailed embodiments.

Referring to FIGS. 1 and 2 together, an embodiment of the present disclosure provides an LCD device 1000. The LCD device 1000 includes a first substrate 101, a second substrate 102, a liquid crystal layer 103, a lower polarizer 104, an upper polarizer 105, and a backlight module 106. The first substrate 101 is disposed opposite to the second substrate 102. The liquid crystal layer 103 is disposed between the first substrate 101 and the second substrate 102. The upper polarizer 105 is disposed on a side of the second substrate 102 away from the first substrate 101. The lower polarizer 104 is disposed on a side of the first substrate 101 away from the second substrate 102. The backlight module 106 is disposed on a side of the lower polarizer 104 away from the first substrate 101.

In the present embodiment, the LCD device 1000 is in a vertical alignment (VA) display mode. In detail, the first substrate 101 includes a first base 1011 and a pixel electrode 1012 disposed on the first base 1011. The pixel electrode 1012 is located on a side of the first base 1011 close to the liquid crystal layer 103. The second substrate 102 includes a second base 1021 and a common electrode 1022 disposed on the second base 1021. The common electrode 1022 is located on a side of the second base 1021 close to the liquid crystal layer 103. The common electrode 1022 is disposed opposite to the pixel electrode 1012.

The first base 1011 and the second base 1021 both may be a hard substrate, for example, a glass substrate. It is to be noted that, in the present embodiment, a film layer structure (not shown in the figure), such as a thin film transistor functional layer, is further disposed between the first base 1011 and the pixel electrode 1012. An alignment film (not shown in the figure) may be disposed on each of a side of the pixel electrode 1012 close to the liquid crystal layer 103 and a side of the common electrode 1022 close to the liquid crystal layer 103, to realize the alignment of liquid crystals. The related arts are all the prior art, and are not described in detail herein.

With reference to FIG. 1, the LCD device 1000 has a plurality of pixel regions 100A. Each of the pixel regions 100A includes a first sub-pixel region 100a, a second sub-pixel region 100b, and a third sub-pixel region 100c that are spaced apart from each other in a first direction X. In the present embodiment, the first sub-pixel region 100a is a red sub-pixel region, the second sub-pixel region 100b is a green sub-pixel region, and the third sub-pixel region 100c is a blue sub-pixel region.

In the present embodiment, light emitted by the backlight module 106 is blue light. In detail, a blue light source in the backlight module 106 may include a blue light-emitting diode (LED). The blue LED may be a mini LED or a micro LED. It is to be noted that, for a detailed structure of the backlight module 106, refer to the prior art, which is not described in detail herein.

Compared with the backlight design in the prior art of forming white light in the backlight module by using a blue LED and yellow fluorescent powder, in the present disclosure, the yellow fluorescent powder in the backlight module 106 is omitted, and the blue light emitted by the blue light source is caused to directly enter the film layer structure in the LCD device 1000, such as the lower polarizer 104. Therefore, the loss of light energy due to excessive low excitation efficiency of the yellow fluorescent powder is prevented, thereby improving the utilization of the blue light and enhancing the energy efficiency of the backlight module 106.

Further, in this embodiment, the upper polarizer 105 includes a polarization layer 1 and a color conversion layer 2, and the color conversion layer 2 is located on a side of the polarization layer 1 away from the liquid crystal layer 103.

The polarization layer 1 is a core film layer in the upper polarizer 105 for polarization analysis. The polarization layer 1 may be an iodine polarization film. In this case, a material of the polarization layer 1 may include polyvinyl alcohol (PVA) and iodine molecules.

The color conversion layer 2 includes a first color conversion portion 2a, a second color conversion portion 2b, and a light transmissive portion 2c spaced apart from each other. The first color conversion portion 2a and the second color conversion portion 2b are configured to convert light of different colors. The first color conversion portion 2a is located in the first sub-pixel region 100a, the second color conversion portion 2b is located in the second sub-pixel region 100b, and the light transmissive portion 2c is located in the third sub-pixel region 100c.

In the present embodiment, materials of the first color conversion portion 2a and the second color conversion portion 2b both include a color conversion material and a filter material.

In the present embodiment, the color conversion material is a down-conversion material. Therefore, the color conversion layer 2 can convert a light with a short wavelength and high energy into a light with a long wavelength and low energy, to realize color conversion. In detail, a down-conversion material in the first color conversion portion 2a is a red down-conversion material, and a down-conversion material in the second color conversion portion 2b is a green down-conversion material. The first color conversion portion 2a can generate red light when excited by blue light. The second color conversion portion 2b can generate green light when excited by blue light.

In the present embodiment, the down-conversion materials in the first color conversion portion 2a and the second color conversion portion 2b are both fluorescent materials. In detail, the fluorescent material in the first color conversion portion 2a is a red fluorescent material, and the red fluorescent material generates red light when excited by blue light. The red fluorescent material may include red fluorescent powder or a red quantum dot. In detail, the fluorescent material in the second color conversion portion 2b is a green fluorescent material, and the green fluorescent material generates the green light when excited by blue light. The green fluorescent material may include green fluorescent powder or a green quantum dot.

The red fluorescent powder may be Ru-doped Y2O3. The red quantum dot may be a red quantum dot having a core-shell structure. The red quantum dot having the core-shell structure includes a first quantum dot core and a first shell layer wrapped around the first quantum dot core. In detail, a material of the first quantum dot core may include one or more of CdSe, Cd2SeTe, or InAs, and a material of the first shell layer may include one or more of CdS, ZnSe, ZnCdS2, ZnS, or ZnO. The green fluorescent powder may be Ru-doped SrGa2S4. The green quantum dot may be a green quantum dot having a core-shell structure. The green quantum dot having the core-shell structure includes a second quantum dot core and a second shell layers wrapped around the second quantum dot core. In detail, a material of the second quantum dot core may include one or more of ZnCdSe2, InP, or Cd2SSe, and a material of the second shell layers may include one or more of CdS, ZnSe, ZnCdS2, ZnS, or ZnO. It is to be noted that, the materials of the above red fluorescent powder, red quantum dot, green fluorescent powder, and green quantum dot are merely examples. The detailed materials may be selected according to actual application requirements, which are not limited in the present disclosure.

The filter material filters and screens colors by reflecting and absorbing light with a particular wavelength and transmitting the light with the particular wavelength. In the present embodiment, the filter material in the first color conversion portion 2a is a red filter material configured to filter out light of colors except red. The filter material in the second color conversion portion 2b is a green filter material configured to filter out light of colors except green. It is to be noted that, the red filter material and the green filter material both include resin, an inorganic pigment particle, and an organic dye. For related materials, refer to the prior art, which are not described in detail herein.

In the present embodiment, the light transmissive portion 2c includes a blue filter material configured to filter out light of colors except blue. The blue filter material includes resin, an inorganic pigment particle, and an organic dye. For related materials, refer to the prior art, which are not described in detail herein. In addition, in some embodiments, the light transmissive portion 2c may be a transparent color resist layer. In this case, the light transmissive portion 2c does not have a filter function, which is not described in detail herein.

Blue light is used as an example, a conventional light path process of the backlight in the LCD is: blue light→lower polarizer 100→liquid crystal layer→color filter (CF) layer→upper polarizer. During experiment, the inventor of the present disclosure finds the following problem: If the fluorescent material is doped into a CF layer of a conventional CF substrate, when the LCD device is in a dark state, the blue light passes through the lower polarizer and forms polarized light, and the polarized light excites the fluorescent material. Due to the polarization characteristic of the fluorescent material, when the polarized light passes through the liquid crystal layer and enters the CF substrate, a polarization state of the polarized light passing through the CF substrate is changed. After polarization analysis by the upper polarizer, light leakage occurs in the dark state.

Therefore, in the present embodiment, the color conversion layer 2 concurrently doped with both the fluorescent material and the filter material is integrated in the upper polarizer 105, and the color conversion layer 2 is located on a side of the polarization layer 1 away from a liquid crystal layer 103. When the LCD device 1000 is in the dark state, the light path process of the backlight is: blue light→lower polarizer 104→liquid crystal layer 103→polarization layer 1→color conversion layer 2. Since the polarized light passing through the liquid crystal layer 103 enters the color conversion layer 2 only after polarization analysis by the polarization layer 1, that is to say, the polarization state of the polarized light is not changed before the polarized light enters the polarization layer 1, light leakage does not occur in the dark state. In this way, the contrast of the LCD device 1000 can be greatly improved, thereby increasing the market competitiveness of the display product.

In some embodiments, the color conversion material is an up-conversion material. Therefore, the color conversion layer 2 can convert a light with a long wavelength and low energy into a light with a short wavelength and high energy, to realize color conversion. In detail, an up-conversion material in the first color conversion portion 2a is a green up-conversion material, and an up-conversion material in the second color conversion portion 2b is a blue up-conversion material. The first color conversion portion 2a can generate green light when excited by red light. The second color conversion portion 2b can generate blue light when excited by red light.

The up-conversion material may include an up-conversion nanoparticle doped with a lanthanide element, such as a rare earth element. Exemplarily, the up-conversion nanoparticle may be an erbium-ytterbium-co-doped yttrium sodium tetrafluoride (NaYF4: Yb, Er) nanoparticle, a neodymium-thulium-ytterbium-co-doped yttrium sodium tetrafluoride (NaYF4: Yb, Nd, Tm) nanoparticle, or a thulium-ytterbium-co-doped yttrium sodium tetrafluoride (NaYF4: Yb, Tm) nanoparticle.

Further, in the present embodiment, the upper polarizer 105 further includes light-shielding portions 2d. The light-shielding portions 2d are respectively located between the first color conversion portion 2a and the second color conversion portion 2b, between the first color conversion portion 2a and the light transmissive portion 2c, and between the second color conversion portion 2b and the light transmissive portion 2c. By means of the light-shielding portions 2d, color crosstalk between the adjacent color conversion portions and between the color conversion portions and the light transmissive portion 2c can be avoided, enhancing the display effect. In detail, the light-shielding portions 2d each may be made of a material having a light absorption function, such as a black matrix.

Still referring to FIG. 2, in the present embodiment, the upper polarizer 105 further includes a first protective layer 3, a protective film 4, a first bonding layer 5, a second protective layer 6, a third protective layer 7, and a second bonding layer 8.

The first protective layer 3 is located between the polarization layer 1 and the color conversion layer 2. The polarization layer 1 contains iodine. By means of the first protective layer 3, iodine molecules in the polarization layer 1 can be prevented from intruding into the color conversion layer 2 and contaminating the fluorescent material in the color conversion layer 2. In detail, a material of the first protective layer 3 may include cellulose triacetate (TAC).

The protective film 4 is located on a side of the color conversion layer 2 away from the polarization layer 1. The protective film 4 is configured to maintain the rigidity and the stiffness of the upper polarizer 105. A material of the protective film 4 may be polyethylene (PE) or polyethylene terephthalate (PET).

The first bonding layer 5 is located between the protective film 4 and the color conversion layer 2. The first bonding layer 5 is configured to increase the stability of the attachment between the protective film 4 and the color conversion layer 2. A material of the first bonding layer 5 may be a pressure sensitive adhesive.

The second protective layer 6 is located between the color conversion layer 2 and the first bonding layer 5. By means of the second protective layer 6, an adhesive material in the first bonding layer 5 can be prevented from coming into direct contact with the color conversion layer 2 and damaging the color conversion layer 2. In detail, a material of the second protective layer 6 may include TAC.

The third protective layer 7 is located on a side of the polarization layer 1 away from the color conversion layer 2. The third protective layer 7 is configured to protect the polarization layer 1. A material of the third protective layer 7 may include TAC.

The second bonding layer 8 is located between the third protective layer 7 and the second substrate 102. A material of the second bonding layer 8 may be the pressure sensitive adhesive.

Referring to FIG. 3, a second embodiment of the present disclosure provides a liquid crystal display device 1000. A difference between the liquid crystal display device 1000 provided in the second embodiment of the present disclosure and that in the first embodiment is as follows: A material of the first color conversion portion 2a includes a red fluorescent material, a material of the second color conversion portion 2b includes a green fluorescent material, and the upper polarizer 105 further includes a blue light absorption layer 10 and a blue filter portion 11. The blue light absorption layer 10 is located on sides of the first color conversion portion 2a and the second color conversion portion 2b away from the polarization layer 1. The blue filter portion 11 is disposed on a same layer as the blue light absorption layer 10 and is located on a side of the light transmissive portion 2c away from the polarization layer 1.

In the present embodiment, by means of the blue light absorption layer 10 disposed on the sides of the first color conversion portion 2a and the second color conversion portion 2b away from the polarization layer 1, blue light in ambient light can be absorbed. In this way, the red fluorescent material in the first color conversion portion 2a and the green fluorescent material in the second color conversion portion 2b are prevented from being interfered with by excitation of the blue light in the ambient light.

In the present embodiment, the material of the first color conversion portion 2a further includes a first substrate material. The first color conversion portion 2a is formed by doping the red fluorescent material into the first substrate material. A material of the second color conversion portion 2b further includes a second substrate material. The second color conversion portion 2b is formed by doping the green fluorescent material into the second substrate material. The first substrate material is same as the second substrate material. Both may be a transparent resin. In some embodiments, the material of the first color conversion portion 2a may further include a red filter material, and the material of the second color conversion portion 2b may further include a green filter material. Details are not described herein.

In the present embodiment, the blue light absorption layer 10 includes a red filter portion 10a and a green filter portion 10b. The red filter portion 10a is located on a side of the first color conversion portion 2a away from the polarization layer 1. The green filter portion 10b is located on a side of the second color conversion portion 2b away from the polarization layer 1. The red filter portion 10a includes a red filter material configured to filter out light of colors except green. The green filter portion 10b includes a green filter material configured to filter out light of colors except green. The blue filter portion 11 includes a blue filter material configured to filter out light of colors except blue. The red filter material, the green filter material, and the blue filter material all include a resin, an inorganic pigment particle, and an organic dye. For related materials, refer to the prior art, which are not described in detail herein.

Referring to FIG. 4, a third embodiment of the present disclosure provides a liquid crystal display device 1000. A difference between the liquid crystal display device 1000 provided in the third embodiment of the present disclosure and that in the second embodiment is as follows: The light transmissive portion 2c and the blue filter portion 11 are integrally formed.

In detail, the light transmissive portion 2c and the blue filter portion 11 are simultaneously produced using the same process. According to the above arrangement, the light transmissive portion 2c is directly formed when the blue filter portion 11 is formed, and in this way, the process can be simplified, so that the process cost is reduced.

The liquid crystal display (LCD) device provided in the embodiments of the present disclosure is described in detail above. The principle and implementations of the present invention are described herein through specific examples. The description about the embodiments of the present disclosure is merely provided to help understand the technical solutions and core ideas of the present invention. Meanwhile, a person of ordinary skill in the art may make modifications to the specific implementations and application range according to the idea of the present disclosure. In conclusion, the content of this specification is not construed as a limit on the present disclosure.

What is claimed is:

1. A liquid crystal display device, comprising:
a first substrate;
a second substrate disposed opposite to the first substrate;
a liquid crystal layer disposed between the first substrate and the second substrate; and
an upper polarizer disposed on a side of the second substrate away from the liquid crystal layer, wherein the upper polarizer comprises a polarization layer and a color conversion layer, and the color conversion layer is located on a side of the polarization layer away from the liquid crystal layer.

2. The liquid crystal display device according to claim 1, wherein the upper polarizer further comprises a first protective layer, and the first protective layer is located between the polarization layer and the color conversion layer.

3. The liquid crystal display device according to claim 1, wherein the upper polarizer further comprises a protective film and a first bonding layer, the protective film is located on a side of the color conversion layer away from the polarization layer, and the first bonding layer is located between the protective film and the color conversion layer.

4. The liquid crystal display device according to claim 3, wherein the upper polarizer further comprises a second protective layer, and the second protective layer is located between the color conversion layer and the first bonding layer.

5. The liquid crystal display device according to claim 4, wherein a third protective layer and a second bonding layer are successively disposed on a side of the polarization layer away from the color conversion layer, and the third protective layer is disposed between the polarization layer and the second bonding layer.

6. The liquid crystal display device according to claim 1, wherein the liquid crystal display device comprises a plurality of pixel regions, each of the pixel regions comprises a first sub-pixel region, a second sub-pixel region, and a third sub-pixel region, the color conversion layer comprises a first color conversion portion, a second color conversion portion, and a light transmissive portion that are spaced apart from each other, the first color conversion portion and the second color conversion portion are configured to convert light of different colors, the first color conversion portion is located in the first sub-pixel region, the second color conversion portion is located in the a second sub-pixel region, and the light transmissive portion is located in the third sub-pixel region.

7. The liquid crystal display device according to claim 6, wherein the first sub-pixel region is a red sub-pixel region, the second sub-pixel region is a green sub-pixel region, and the third sub-pixel region is a blue sub-pixel region, light emitted by a backlight module of the liquid crystal display device is blue light, a material of the first color conversion portion comprises a red fluorescent material and a red filter material, a material of the second color conversion portion comprises a green fluorescent material and a green filter material, and the light transmissive portion comprises a blue filter material.

8. The liquid crystal display device according to claim 7, wherein the red fluorescent material comprises red fluorescent powder or a red quantum dot, and the green fluorescent material comprises green fluorescent powder or a green quantum dot.

9. The liquid crystal display device according to claim 6, wherein the first sub-pixel region is a red sub-pixel region, the second sub-pixel region is a green sub-pixel region, and the third sub-pixel region is a blue sub-pixel region, light emitted by a backlight module of the liquid crystal display device is blue light, a material of the first color conversion portion comprises a red fluorescent material, a material of the second color conversion portion comprises a green fluorescent material, and the polarizer further comprises a blue light absorption layer, wherein the blue light absorption layer is located on sides of the first color conversion portion and the second color conversion portion away from the polarization layer.

10. The liquid crystal display device according to claim 9, wherein the blue light absorption layer comprises a red filter portion and a green filter portion, wherein the red filter portion is located on a side of the first color conversion portion away from the polarization layer, and the green filter portion is located on a side of the second color conversion portion away from the polarization layer.

11. The liquid crystal display device according to claim 9, wherein a material of the light transmissive portion comprises a blue filter material, and the upper polarizer further comprises a blue filter portion, wherein the blue filter portion is disposed on a same layer as the blue light absorption layer and located on a side of the light transmissive portion away from the polarization layer.

12. The liquid crystal display device according to claim 11, wherein the light transmissive portion and the blue filter portion are integrally formed.

13. The liquid crystal display device according to claim 6, wherein the upper polarizer further comprises light-shielding portions, and the light-shielding portions are respectively located between the first color conversion portion and the second color conversion portion, between the first color conversion portion and the light transmissive portion, and the second color conversion portion and the light transmissive portion.

14. A liquid crystal display (LCD) device, comprising:
a first substrate;
a second substrate disposed opposite to the first substrate;
a liquid crystal layer disposed between the first substrate and the second substrate; and
an upper polarizer disposed on a side of the second substrate away from the liquid crystal layer; wherein the upper polarizer comprises a polarization layer, a color conversion layer, a first protective layer, a protective film, and a first bonding layer, the color conversion layer is located on a side of the polarization layer away from the liquid crystal layer, the first protective layer is located between the polarization layer and the color conversion layer, the protective film is located on a side of the color conversion layer away from the polarization layer, and the first bonding layer is located between the protective film and the color conversion layer.

15. The liquid crystal display device according to claim 14, wherein the liquid crystal display device comprises a plurality of pixel regions, each of the pixel regions comprises a first sub-pixel region, a second sub-pixel region, and a third sub-pixel region, the color conversion layer comprises a first color conversion portion, a second color conversion portion, and a light transmissive portion that are spaced apart from each other, the first color conversion portion and the second color conversion portion are configured to convert light of different colors, the first color conversion portion is located in the first sub-pixel region, the second color conversion portion is located in the a second sub-pixel region, and the light transmissive portion is located in the third sub-pixel region.

16. The liquid crystal display device according to claim 15, wherein the first sub-pixel region is a red sub-pixel region, the second sub-pixel region is a green sub-pixel region, and the third sub-pixel region is a blue sub-pixel region, light emitted by a backlight module of the liquid crystal display device is blue light, a material of the first color conversion portion comprises a red fluorescent material and a red filter material, a material of the second color conversion portion comprises a green fluorescent material and a green filter material, and the light transmissive portion comprises a blue filter material.

17. The liquid crystal display device according to claim 16, wherein the red fluorescent material comprises red fluorescent powder or a red quantum dot, and the green fluorescent material comprises green fluorescent powder or a green quantum dot.

18. The liquid crystal display device according to claim 15, wherein the first sub-pixel region is a red sub-pixel region, the second sub-pixel region is a green sub-pixel region, and the third sub-pixel region is a blue sub-pixel region, light emitted by a backlight module of the liquid crystal display device is blue light, a material of the first color conversion portion comprises a red fluorescent material, a material of the second color conversion portion comprises a green fluorescent material, and the polarizer further comprises a blue light absorption layer, wherein the blue light absorption layer is located on sides of the first color conversion portion and the second color conversion portion away from the polarization layer.

19. The liquid crystal display device according to claim 18, wherein the blue light absorption layer comprises a red filter portion and a green filter portion, wherein the red filter portion is located on a side of the first color conversion portion away from the polarization layer, and the green filter portion is located on a side of the second color conversion portion away from the polarization layer.

20. The liquid crystal display device according to claim 18, wherein a material of the light transmissive portion comprises a blue filter material, and the upper polarizer further comprises a blue filter portion, wherein the blue filter portion is disposed on a same layer as the blue light absorption layer and located on a side of the light transmissive portion away from the polarization layer.
